(19) United States
(12) Patent Application Publication
(10) Pub. No.: US 2012/0050653 A1
(43) Pub. Date: Mar. 1, 2012

(54) LIQUID CRYSTAL DISPLAY DEVICE

(75) Inventor: Yasunari Nagata, Yasu (JP)

(73) Assignee: KYOCERA CORPORATION, Shiga (JP)

(21) Appl. No.: 13/221,412

(22) Filed: Aug. 30, 2011

(30) Foreign Application Priority Data
Aug. 30, 2010 (JP) 2010-192459
Aug. 30, 2011 (JP) 2011-186935

(51) Int. Cl. G02F 1/1335; G02F 1/1337

(52) U.S. Cl. 349/106; 349/123; 349/110

(57) ABSTRACT

A liquid crystal display device includes a first substrate; a second substrate on which an orientation film is formed to face the first substrate; a liquid crystal layer interposed between the first substrate and the orientation film formed on the second substrate and; a spacer fixed to the first substrate. The spacer includes a top portion facing the orientation film and having a concave part at a central area of the top portion and a side surface having a convex surface curved from the top portion to the first substrate.

### FIELD OF THE INVENTION

The present invention relates to a liquid crystal display device to be used for various purposes, such as a portable phone, a digital camera, a portable game machine, and a portable information device.

### BACKGROUND OF THE INVENTION

A liquid crystal display device includes paired substrates disposed so as to face each other and a liquid crystal layer disposed between these substrates, and a spacer is provided between the paired substrates for the purpose of controlling a space between the substrates (for example, refer to Japanese Unexamined Patent Application Publication No. 7-104282).

This spacer has one end fixed to one of the paired substrates and the other end having a top portion facing the other substrate, and this top portion is in the vicinity of the other substrate. For example, when the liquid crystal display device receives a load by external forces, while the space is going to become narrowed, the top portion of this spacer makes contact with the other substrate and the spacer presses the one substrate and the other substrate, thereby allowing the space between the substrates to be controlled.

However, the shape of this top portion in the central region is in a convex shape protruding to the other substrate side. Therefore, for example, when the paired substrates receive a load, an area of an orientation film provided on the other substrate to be pressed by the top portion of the spacer tends to be small and a large pressing force is partially added to the orientation film, thereby damaging the orientation film and degrading display quality.

The present invention was made in view of the problem described above, and has an object of providing a liquid crystal display device capable of suppressing degradation in display quality.

### SUMMARY OF THE INVENTION

According to one embodiment of the invention, a liquid crystal display device comprising: a first substrate; a second substrate on which an orientation film is formed to face the first substrate; a liquid crystal layer interposed between the first substrate and the orientation film formed on the second substrate and; a spacer fixed to the first substrate wherein the spacer comprises a top portion facing the orientation film and having a concave part at a central area of the top portion and a side surface having a convex curve surface from the top portion to the first substrate.

### BRIEF DESCRIPTION OF THE DRAWINGS

FIG. 1 is a plan view of a liquid crystal display device in a first embodiment of the present invention.

FIG. 2 is a sectional view along II-II line of FIG. 1.

FIG. 3 is a sectional view of a main part of the liquid crystal display device of FIG. 1.

FIG. 4 is a plan view of electrodes and spacers on a second substrate.

FIG. 5 is a sectional view along V-V line of FIG. 4.

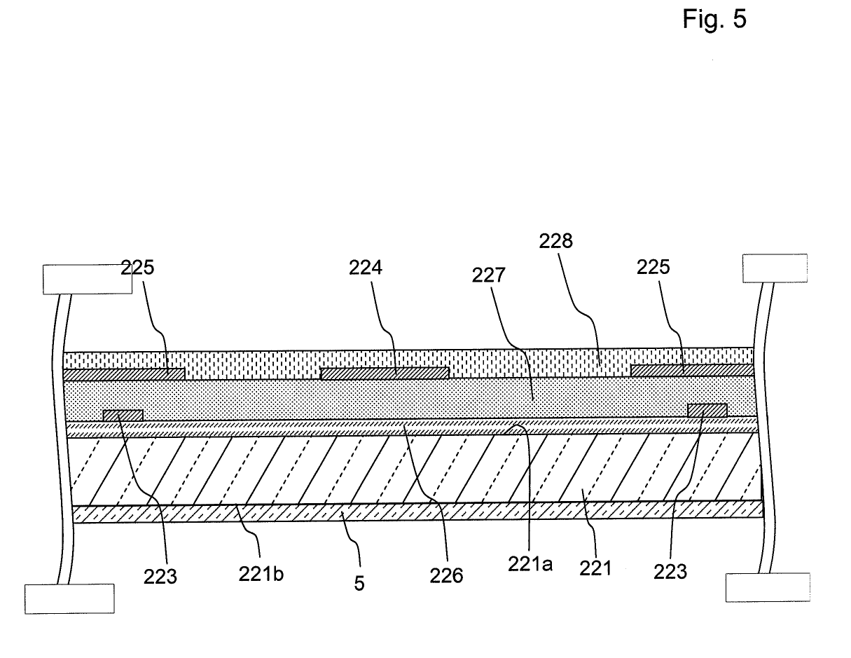

FIG. 6A is a plan view of a spacer observed from a second substrate side.

FIG. 6B is a view of a section of the spacer of FIG. 6A.

FIG. 7A is an enlarged sectional view of an R1 portion of FIG. 6B.

FIG. 7B is an enlarged sectional view of an R2 portion of FIG. 6B.

FIG. 8 is a plan view of the spacers in a display region and a non-display region.

FIG. 9 is a view of a section of the spacers along IX-IX line of FIG. 8.

FIG. 10 is a sectional view of a main part of a liquid crystal display device in a second embodiment of the present invention.

### DESCRIPTION OF THE PREFERRED EMBODIMENTS

### First Embodiment

First, a liquid crystal display device 1 in a first embodiment of the present invention is described.

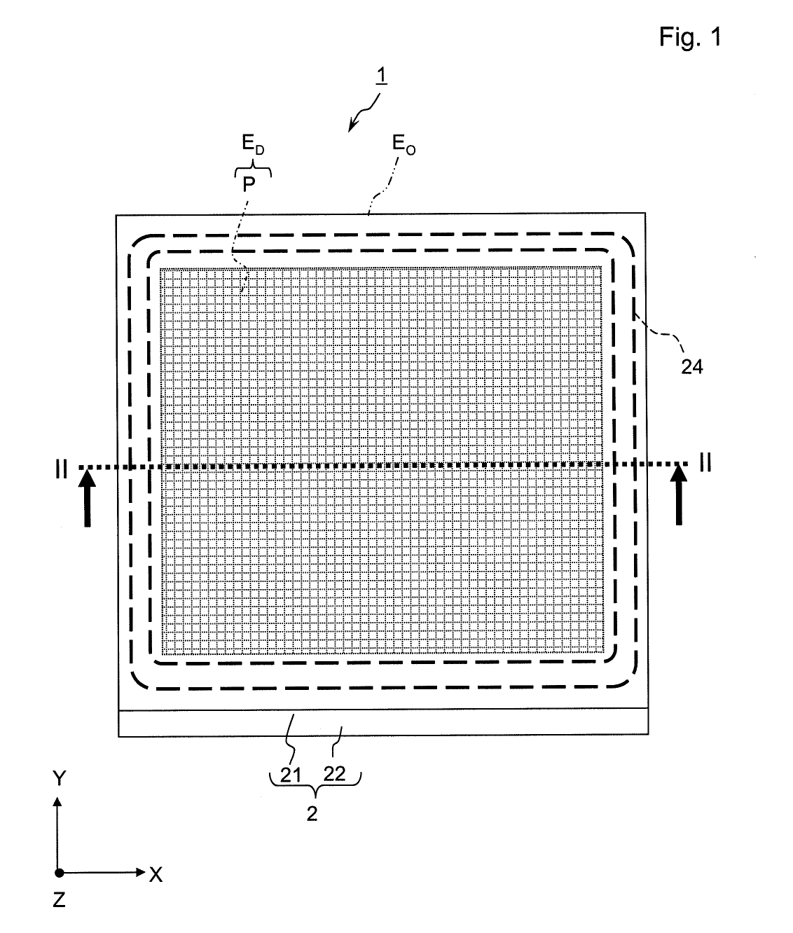

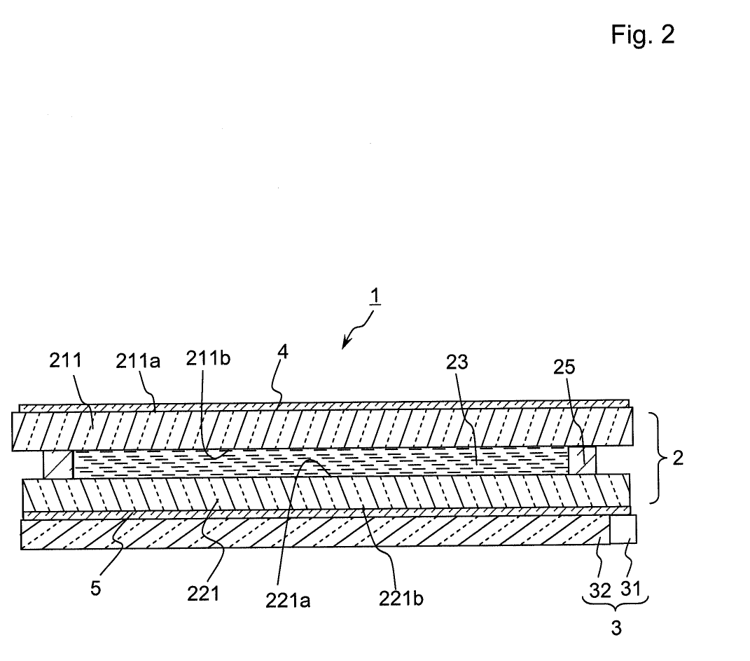

As illustrated in FIG. 1 and FIG. 2, the liquid crystal display device 1 includes a liquid crystal panel 2, a light source device 3, a first polarizing plate 4, and a second polarizing plate 5.

The liquid crystal panel 2 has a first substrate 21, a second substrate 22, a liquid crystal layer 23, spacers 24, and a sealing member 25.

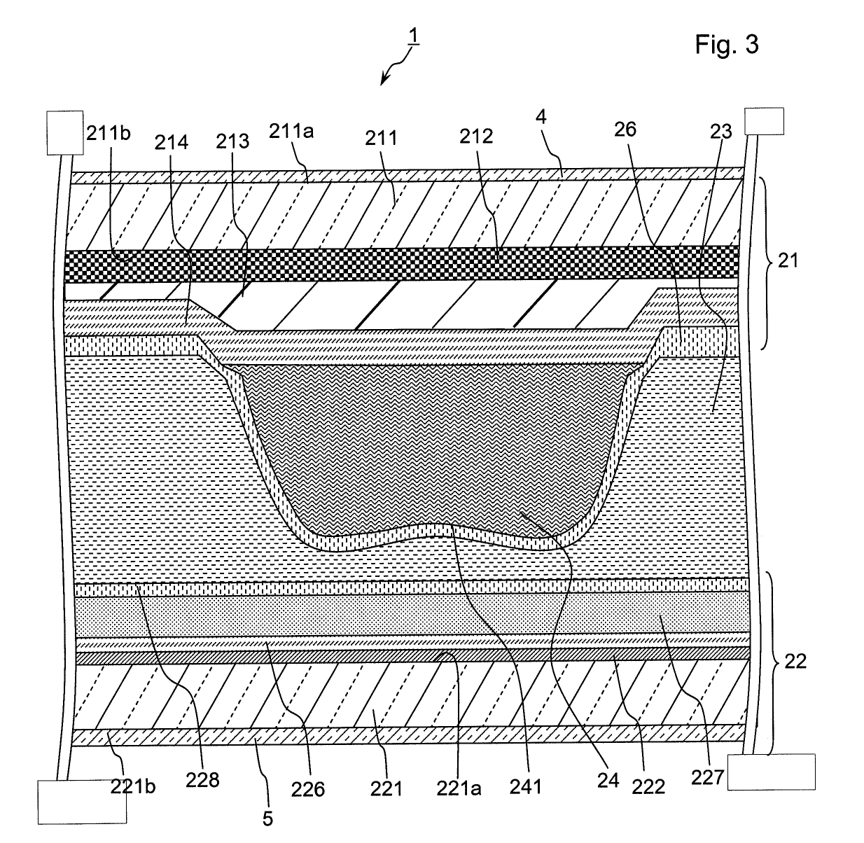

The first substrate 21 is a so-called CF (Color Filter) substrate. As illustrated in FIG. 3, the first substrate 21 has a first transparent board 211, a light shielding pattern 212, color filters 213, and a planarizing film 214.

The first transparent board 211 has a function of supporting the members mentioned above. Also, the first transparent board 211 has a first main surface 211a for use as a display surface at the time of image display and a second main surface 211b positioned on a side opposite to the first main surface 211a. The first transparent board 211 is formed of a translucent material, for example, glass or plastic.

The light shielding pattern 212 has a function of shielding against light. The light shielding pattern 212 is provided in a lattice shape so as to extend in an X direction or a Y direction on the second main surface 211b of the first transparent board 211. The light shielding pattern 212 is provided in a lattice shape along an outer perimeter of each pixel P on the second main surface 211b of the first transparent board 211. The material of the light shielding pattern 212 may be resin including a colorant or pigment (for example, carbon or resin carbon having carbon coated with resin) of a color with a high light-shielding effect (for example, black), or metal, such as chrome or chromic oxide. The light shielding pattern 212 according to this embodiment is formed in a lattice shape but may be formed in any other shape.

The color filters 213 have a function of transmitting only visible light of a specific wavelength. The plurality of color filters 213 are provided on the second main surface 211b of the first transparent board 211 and are provided for the respective pixels P. Each of the color filters 213 has any one of colors red (R), green (G), and blue (B). Each color filter 213 may have not only one of the colors mentioned above but another color, for example, yellow (Y) or white (W). The material of the color filters 213 may be resin including a colorant or pigment.

Part of the color filters 213 is provided so as to cover the light shielding pattern 212. Here, a distance between the spacers 24 and the second substrate 22 can be changed by adjusting the thickness of the color filters 213 that cover the light shielding pattern 212.

The planarizing film 214 has a function of planarizing a surface of the first substrate 21. The planarizing film 214 is provided on the first transparent board 211 so as to cover the light shielding pattern 212 and the color filters 213. The material of the planarizing film 214 may be resin, such as acrylic resin.

The second substrate 22 is a so-called TFT (Thin Film Transistor) substrate. The second substrate 22 has a second transparent board 221, gate lines 222, source lines 223, thin film transistors TFT, pixel electrodes 224, common electrodes 225, a first interlayer insulating film 226, a second interlayer insulating film 227, and an orientation film 228.

In the liquid crystal display device 1, the pixels P are disposed in a matrix. On the second transparent board 221, provided are the plurality of gate lines 222 arranged along the Y direction and the plurality of source lines 223 arranged along the X direction so as to cross each of the gate lines 222. The pixels P are each defined by a region surrounded by the plurality of gate lines 222 and the plurality of source lines 223.

Each of the gate lines 222 extends along the X direction, and one gate line 222 is connected to a plurality of thin film transistors TFT. Also, each of the source lines 223 extends along the Y direction. To each of the source lines 223, the pixel electrode 224 is connected via the thin film transistor TFT.

When a voltage is applied to one gate line 222, the resistance of a semiconductor layer of the thin film transistor TFT connected to that gate line 222 is changed, thereby letting a current flow through that thin film transistor TFT (this represents an ON state). With the thin film transistor TFT being in an ON state, when an image signal is applied to the source line 223, the image signal is written from the source line 223 to the pixel electrode 224 via the thin film transistor TFT. Based on the image signal, an electric field is generated between the pixel electrode 224 and the common electrode 225. Thus, the arrangement of liquid crystal molecules positioned at each pixel P can be controlled.

The second transparent board 221 has a function of supporting the members mentioned above. Also, in addition to the above-mentioned members, the second transparent board 221 has a first main surface 221a facing the second main surface 211b of the first transparent board 211 and a second main surface 221b positioned on a side opposite to the first main surface 221a. The material of the second transparent board 221 can be similar to that of the first transparent board 211.

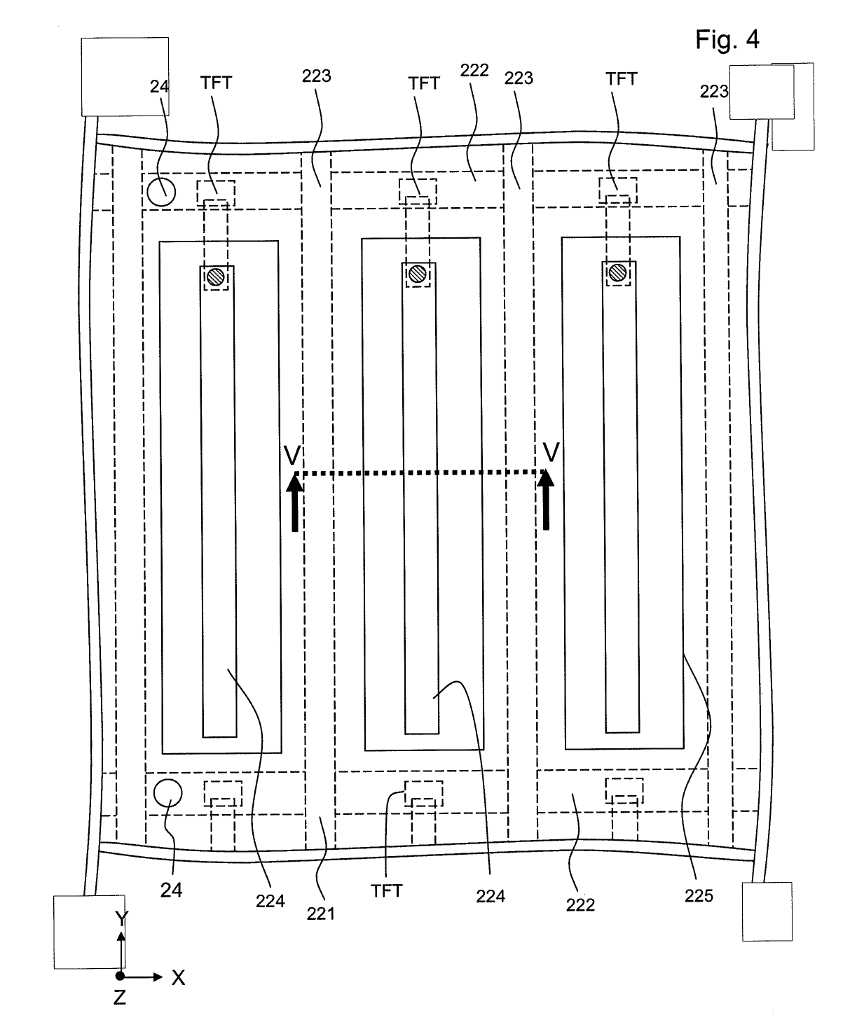

The gate lines 222 have a function of applying a voltage to the thin film transistors TFT. As illustrated in FIG. 4, the gate lines 222 are formed so as to extend in the X direction. Also, the plurality of gate lines 222 are arranged along the Y direction on the first main surface 221a of the second transparent board 221. Furthermore, the gate lines 222 are disposed so as to face the light shielding pattern 212 of the first substrate 21 in this embodiment, however, they may be disposed in any other manner. The material of the gate lines 222 may be a conductive material, for example, aluminum, molybdenum, titanium, neodymium, or an alloy containing any of these elements.

The first interlayer insulating film 226 is provided on the first main surface 22a so as to cover the gate lines 222. The first interlayer insulating film 226 is formed of an insulating material, such as silicon nitride or silicon oxide. Note that the first interlayer insulating film 226 can be formed on the first main surface 221a of the second transparent board 221 by sputtering, vapor deposition, chemical-vapor deposition, or the like.

The source lines 223 have a function of applying a voltage to the pixel electrodes 224 via the thin film transistors TFT. As illustrated in FIG. 4, the source lines 223 are formed so as to extend in the Y direction. Also, the plurality of source lines 223 are arranged along the X direction on the first interlayer insulating film 226. Furthermore, the source lines 223 are provided so as to face the light shielding pattern 212 of the first substrate 22 in this embodiment, however, they may be disposed in any other manner. The source lines 223 may be formed of a material similar to the material of the gate lines 222.

The second interlayer insulating film 227 is provided on the first interlayer insulating film 226 so as to cover the source lines 223. The second interlayer insulating film 227 may be formed of an insulating material, for example, an organic material, such as acrylic-base resin or epoxy-base resin.

In each of the thin film transistors TFT, with the resistance of the semiconductor layer between the source electrode and the drain electrode being changed according to the voltage applied to the semiconductor layer via the gate line 222, writing or non-writing of the image signal to the pixel electrode 224 is controlled.

The pixel electrodes 224 each have a function of causing an electric field between itself and the common electrode 225 with the voltage applied from a driver. The pixel electrodes 224 are provided on the second interlayer insulating film 227. The material of the pixel electrodes 224 may be a translucent and conductive material, for example, ITO (Indium Tin Oxide), IZO (Indium Zinc Oxide), ATO (Antimony Tin Oxide), AZO (Al-Doped Zinc Oxide), tin oxide, zinc oxide, and conductive polymers (such as PEDOT and PSS).

The common electrodes 225 each have a function of causing an electric field between itself and the pixel electrode 224 with the voltage applied from the driver. The common electrodes 225 are provided on the second interlayer insulating film 227. While the common electrodes 225 and the pixel electrodes 224 are provided on the same plane, they are positioned so as to be apart from each other. The material of the common electrodes 225 may be a translucent and conductive material similar to that of the pixel electrodes 224.

The orientation film 228 has a function of controlling the orientation of liquid crystal molecules of the liquid crystal layer 23. The orientation film 228 is provided on the second transparent board 221 so as to cover the pixel electrodes 224 and the common electrodes 225. The material of the orientation film 228 may be resin, such as polyimide resin.

The liquid crystal layer 23 is provided between the first substrate 21 and the second substrate 22. The liquid crystal layer 23 contains molecules of liquid crystal, such as nematic liquid crystal, cholesteric liquid crystal, or smectic liquid crystal.

The spacers 24 have a function of controlling a space between the first substrate 21 and the second substrate 22. As illustrated in FIG. 3, each spacer 24 is provided between the first substrate 21 and the second substrate 22. Also, the spacer 24 has one end fixed to the first substrate 21. The spacer 24 is provided so as to overlap the light shielding pattern 212 of the first substrate 21 and is positioned in a region where the light shielding pattern 212 is formed. Furthermore, as illustrated in FIG. 4, each spacer 24 is formed at the density of one per three pixels P, however, the density may be appropriately determined according to the design of the liquid crystal display device 1. The material of the spacers 24 may be, for example, photosensitive resin, such as acrylic resin.

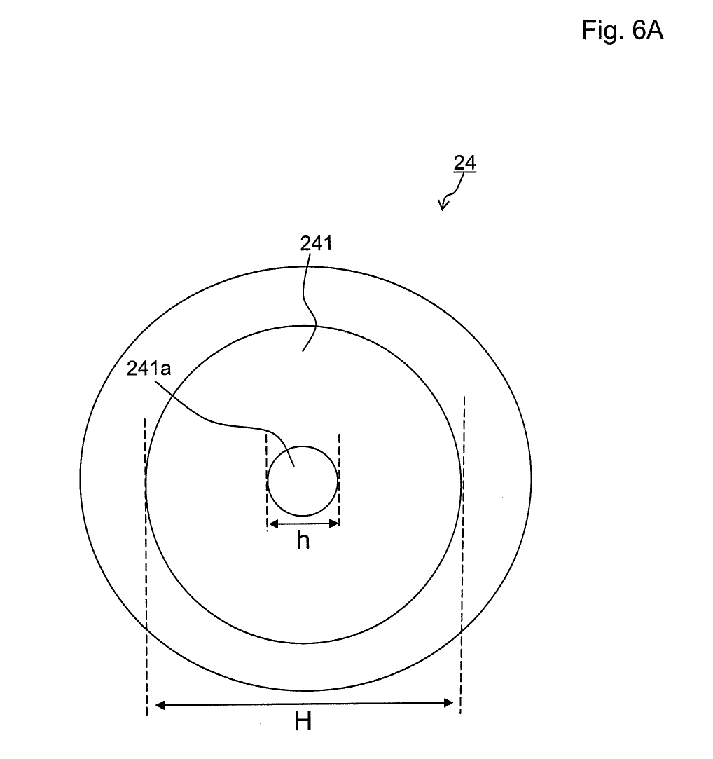

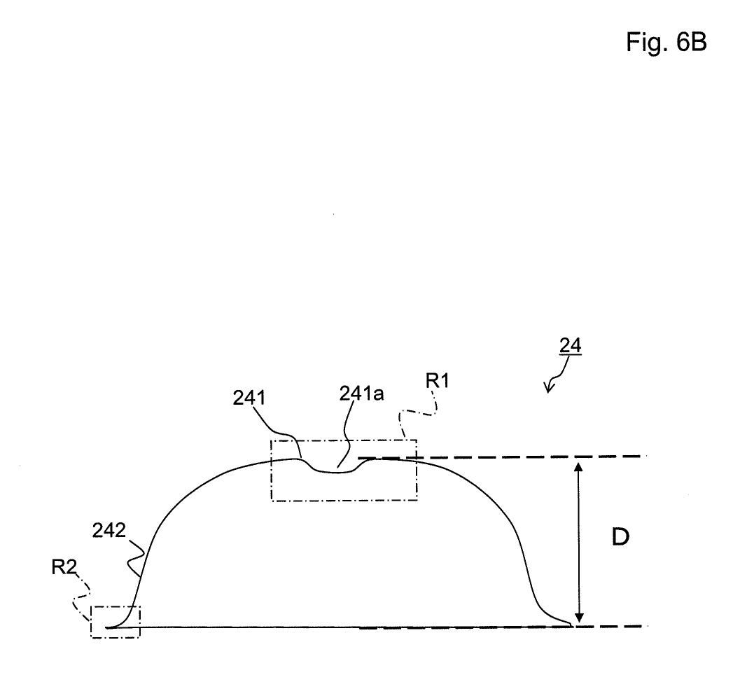

As illustrated in FIG. 3, FIG. 6A, and FIG. 6B, the spacers 24 each have a top portion 241 facing the second substrate 22. The top portion 241 is disposed in the vicinity of the orientation film 228 of the second substrate 22.

Also, as illustrated in FIG. 6A and FIG. 6B, the top portion 241 has a concave part 241a recessed toward the first substrate 21 side. Note that a distance between the top portion 241 of the spacer 24 and the orientation film 228 is set to be equal to or smaller than 0.5 μm.

Furthermore, as illustrated in FIG. 6A, the top portion 241 and the concave part 241a both preferably have a round shape in a planar view. With this, when the spacer 24 presses the orientation film 228 to shrink, a stress applied to the spacer 24 itself can be dispersed.

In the liquid crystal display device 1, the top portion 241 has the concave part 241a. Therefore, for example, even when the liquid crystal display device 1 receives an impact from outside or the spacer 24 expands due to thermal expansion, the area of the orientation film 228 to be pressed by the top portion 241 of the spacer 24 can be increased. Accordingly, the pressing force to the orientation film 228 is dispersed, and therefore it is possible to reduce damages of the orientation film 228 and suppress degradation in display quality.

Still further, as illustrated in FIG. 6B, a side surface 242 of the spacer 24 is a convex surface curved from the top portion 241 to the first substrate 20. When the spacer 24 presses the orientation film 228, the spacer 24 shrinks, and a stress is added to the spacer 24. With the convex side surface 242, the stress applied to the spacer 24 can be dispersed.

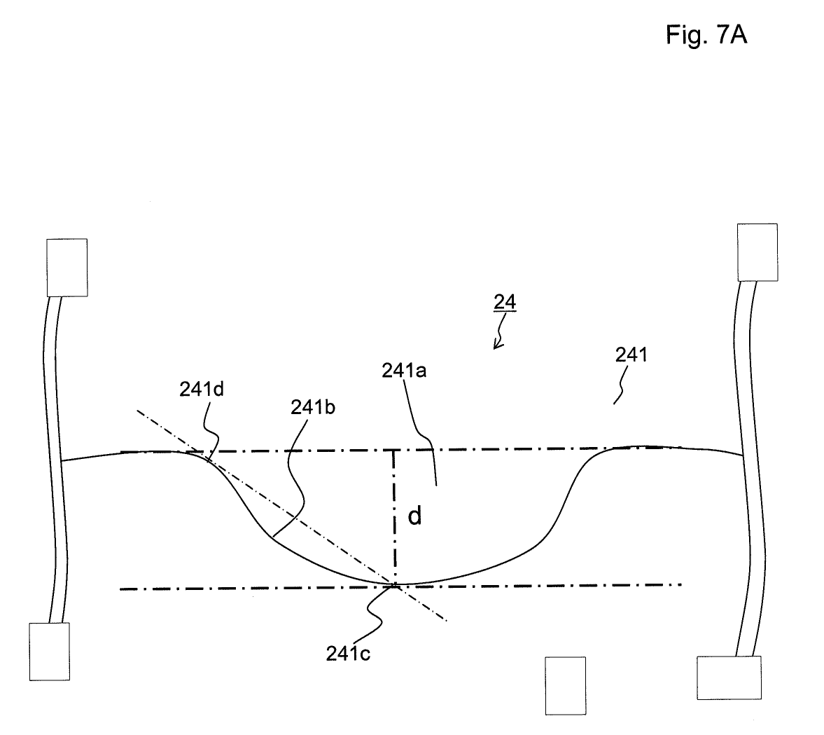

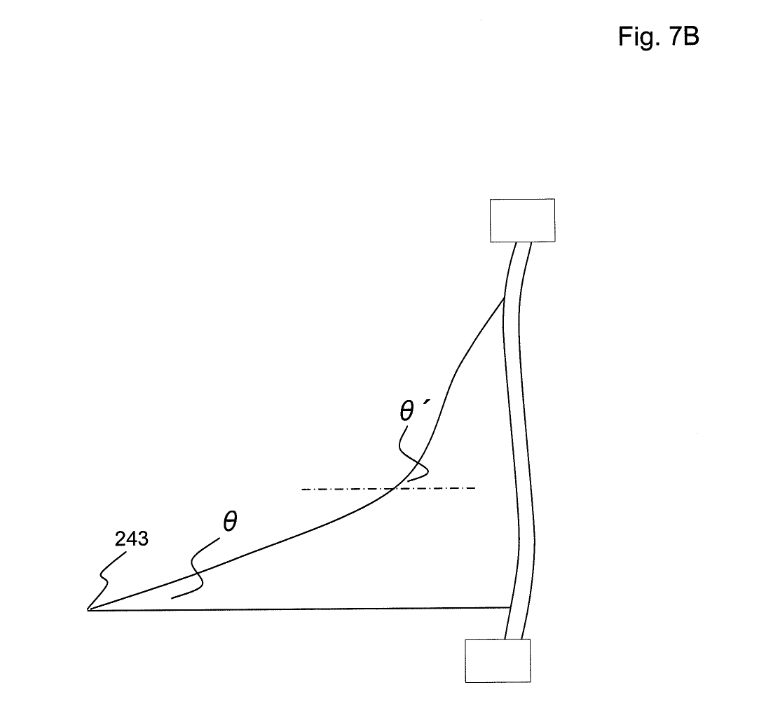

FIG. 7A is an enlarged view of an R1 portion of FIG. 6B. As depicted in FIG. 7A, an inner surface 241b of the concave part 241a is preferably formed of a smoothly curved surface from a periphery of the concave part 241a to a bottom part 241c. With the smoothly curved inner surface 241b, when the spacer 24 presses the orientation film 228, the inner surface 241b of the spacer 24 easily makes contact with the orientation film 228, and the pressing force from the inner surface 241b to the orientation film 228 can be more dispersed.

FIG. 7B is an enlarged view of an R2 portion of FIG. 6B. As illustrated in FIG. 7B, the spacer 24 has an end portion 243 at a boundary with the first substrate 21. Also, θ′ is a tilt angle formed by the first substrate 21 and any portion of the side surface 242 of the spacer 24, and is set to be a minimum tilt angle θ at the end portion 243. With this, an area of attachment between the spacer 24 and the first substrate 21 is increased, thereby increasing intimate contact between the spacer 24 and the first substrate 21. Also, this tilt angle θ between the end portion 243 and the first substrate 21 is preferably set at 10 degrees to 20 degrees. If the tilt angle is below 10 degrees, the end portion 243 would spread to increase an area where the spacer 24 is formed, thereby possibly affecting display quality.

Also, as illustrated in FIG. 7A, the inner surface 241b of the concave part 241a is preferably a recessed surface. With the concave part 241a, when the spacer 24 presses the orientation film 228, a contact area between the inner surface 241b of the concave part 241a and the orientation film 228 can be easily ensured, and the pressure applied from the inner surface 241b of the concave part 241a to the orientation film 228 can be dispersed more satisfactorily. Here, the recessed surface is a surface curved inward from a virtual line connecting the bottom part 241c and an end part 241d of the concave part 241a to the first substrate 21 side.

Furthermore, a depth d of the concave part 241a at the top portion 241 is set at, for example, 1% to 5% of a height D of the spacer 24. Here, when the depth d of the concave part 241a is shallow, the area of the inner surface 241b is also small. In this case, when the spacer 24 presses the orientation film 228, there is a possibility that an area of the top portion 241 of the spacer 24 pressed against the orientation film 228 may not be sufficiently maintained. On the other hand, when the depth d of the concave part 241a is deep, when the spacer 24 presses the orientation film 228, even the bottom face of the concave part 241a cannot press the orientation film 228. Therefore, there is a possibility that the area of the top portion 241 of the spacer 24 pressed against the orientation film 228 may not be sufficiently maintained. For this reason, by setting the depth d of the concave part 241a at the top portion 241 in a range of 1% to 5% of the height D of the spacer 24, a satisfactory area of the top portion 241 of the spacer 24 pressed against the orientation film 228 can be maintained.

Furthermore, as illustrated in FIG. 6A, a width h of the concave part 241a is set equal to or smaller than 20% of a width H of the top portion 241. When the top portion 241 of the spacer 24 presses the orientation film 228, if the width h of the concave part 241a is large, friction between the top portion 241 and the orientation film 228 tends to be increased, a stress tends to be added to the spacer 24 in a horizontal direction, and the spacer 24 tends to be bent. By contrast, when the width h of the concave part 241a is set to be equal to or smaller than 20% of the width H of the top portion 241, a stress to the spacer 24 in a horizontal direction can be decreased, and bending of the spacer 24 can be decreased.

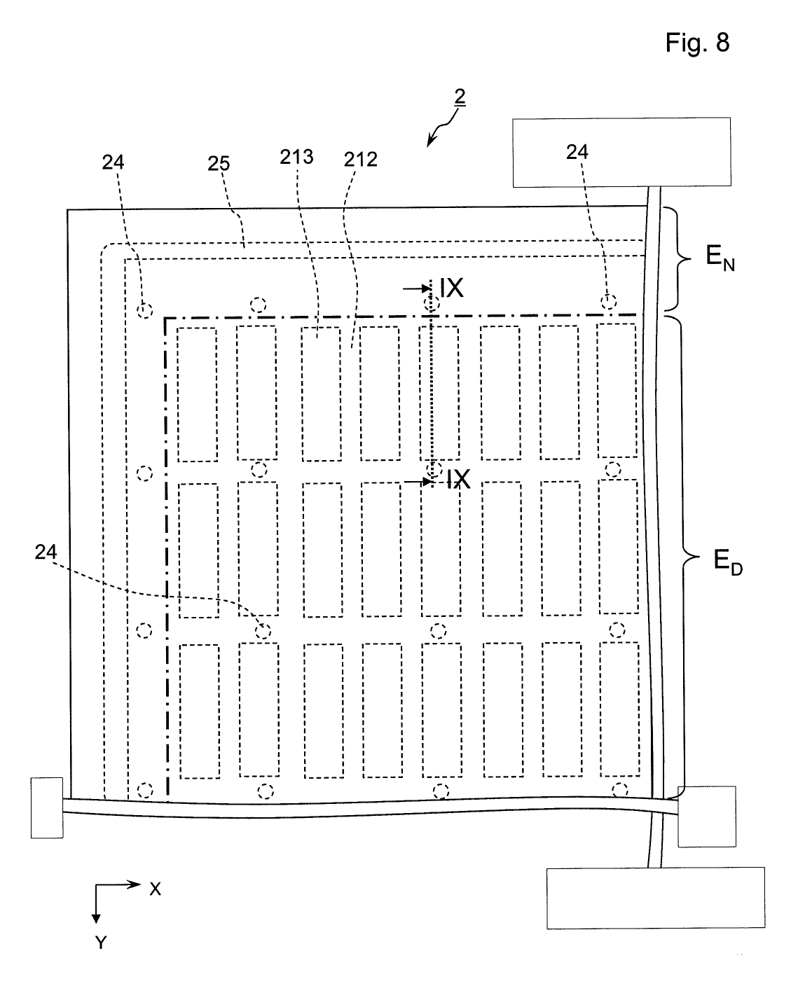

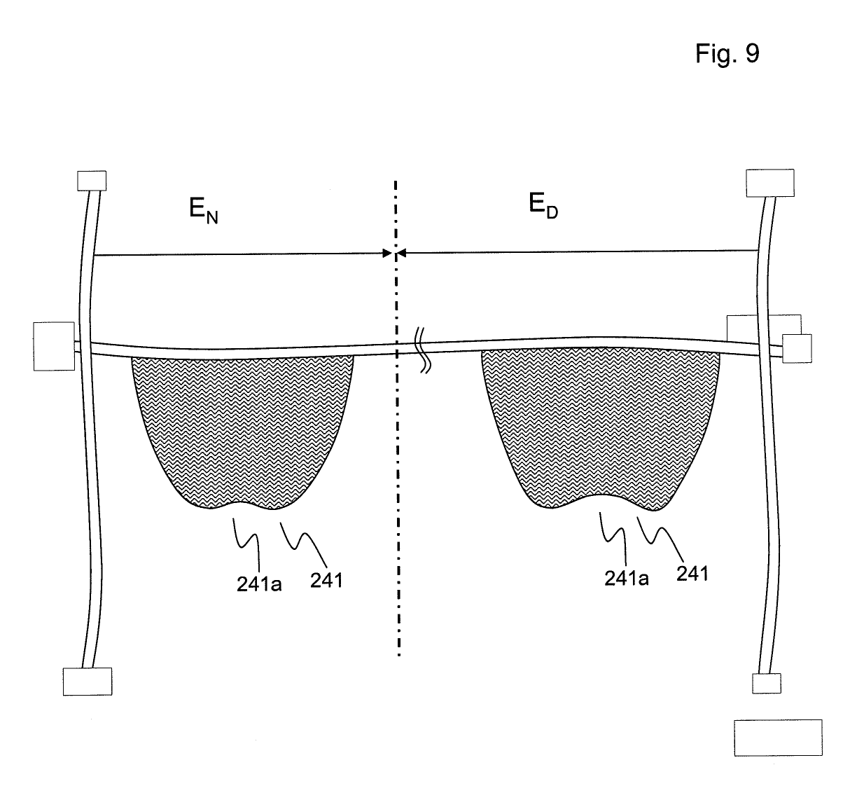

FIG. 8 is a plan view of the liquid crystal panel 2 illustrating part of a display region E_{D} and a non-display region E_{N}. FIG. 9 is a view of a section of the spacers along IX-IX line of FIG. 8. As illustrated in FIG. 8, the spacers 24 are positioned in the display region E_{D} and the non-display region E_{N}. Here, as illustrated in FIG. 9, the size of the concave part 241a at the top portion 241 of the spacer 24 positioned in the non-display region E_{N} is set to be smaller than the size of the concave part 241a at the top portion 241 of the spacer 24 positioned in the display region E_{D}. Here, the size of the concave part 241a can be adjusted by changing the depth d and the width h.

The temperature of the liquid crystal panel 2 tends to become high on a center side compared with the temperature on an outer perimeter side. Since the non-display region E_{N} is positioned outside of the display region E_{D}, the temperature of the non-display region E_{N} tends to become low compared with the temperature of the display region E_{D}. When the temperature becomes low, the liquid crystal layer 23 shrinks, and air bubbles tend to occur due to the shrinkage.

In the liquid crystal display device 1, the size of the concave part 241a at the top portion 241 of the spacer 24 positioned in the non-display region E_{N} is set to be smaller than the size of the concave part 241a at the top portion 241 of the spacer 24 positioned in the display region E_{D}. Thus, the area of the orientation film 228 to be pressed by the spacer 24 positioned in the non-display region E_{N} is decreased. However, since the size of the concave part 241a of the spacer 24 positioned in the non-display region E_{N} is small, the possibility of the occurrence of air bubbles even in a low temperature state can be decreased. On the other hand, even when the area of the second substrate 22 to be pressed by the spacer 24 is decreased, the area is a pressing area in the non-display region E_{N}, and therefore the influence on display quality is small.

Also, when liquid crystal molecules are positioned in the concave part 241a at the top portion 241 of the spacer 24, the liquid crystal molecules function as a cushioning material that lessens the impact when the spacer 24 and the orientation film 228 make contact with each other, and damages of the orientation film 228 can be more effectively reduced.

As a method of forming the spacer 24, the following method may be used, for example.

First, the second main surface 211b of the first transparent board 211 on which the light shielding pattern 212, the color filters 213, and the planarizing film 214 are formed is coated with the resin material described above to form a resin film. Thereafter, a predetermined part of the resin film is exposed by using a mask for development, and an exposed portion of the resin film is processed and heat-cured, thereby forming the spacers 24.

Here, in the process of forming the spacers 24, the distance between the mask and the resin film and others are adjusted and, by using optical diffraction, a portion with an insufficient polymerization reaction is created on an upper surface (the top portion 241) of a portion where the spacer 24 is formed. Then, in a development process, the resin film is removed. Then, by curing after resin viscosity is adjusted with a predetermined temperature condition, the spacers 24 each having the concave part 241a at the top portion 241 are formed.

Also, the spacers 24 are covered with the orientation film 26. The orientation film 26 has a function of controlling the orientation of the liquid crystal layer 23. The orientation film 26 is provided on the first substrate 21 so as to cover the spacer 24.

The sealing member 25 has a function of bonding the first substrate 21 and the second substrate 22 together. The sealing member 25 is provided between the first substrate 21 and the second substrate 22 so as to surround the display region E_{D}.

The light source device 3 has a function of irradiating light toward the first substrate 21 and the second substrate 22 in the display region E_{D}. The light source device 3 has a light source 31 and a light guide plate 32.

The first polarizing plate 4 has a function of selectively transmitting light in a predetermined vibrating direction. The first polarizing plate 4 is positioned outside of the first substrate 21 and the second substrate 22, and is provided to a first main surface 211a side of the first transparent board 211.

The second polarizing plate 5 has a function of selectively transmitting light in a predetermined vibrating direction. The second polarizing plate 5 is disposed so as to face the first polarizing plate 4 via the first substrate 21 and the second substrate 22.

### Second Embodiment

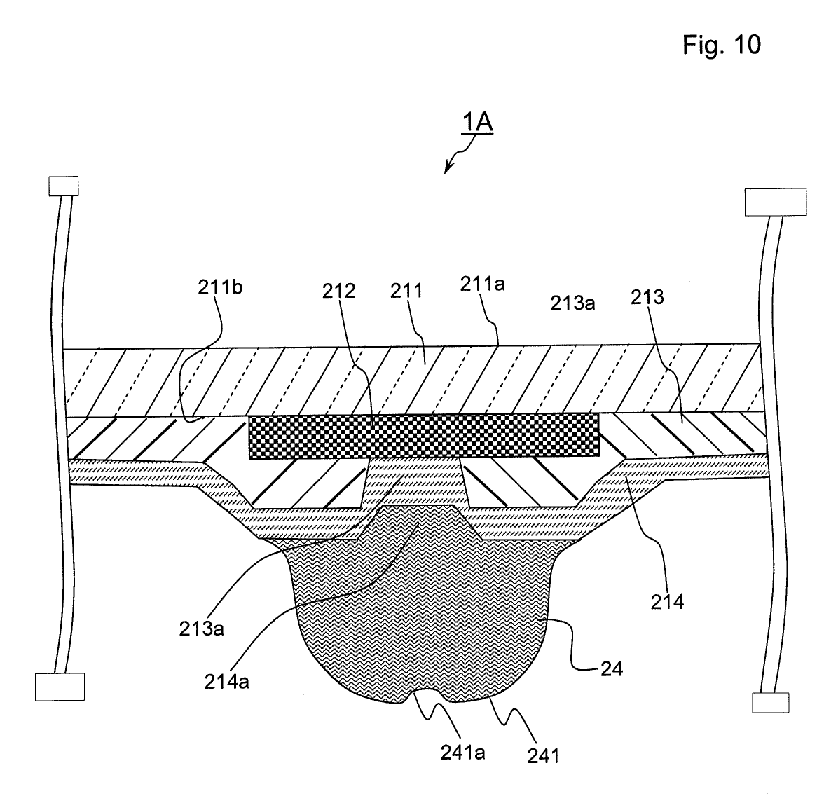

FIG. 10 is a drawing of an example of a liquid crystal display device 1A in a second embodiment.

The liquid crystal display device 1A is different from the liquid crystal display device 1 in that an aperture is provided to part of each color filter 213 that covers the light shielding pattern 212.

In the liquid crystal display device 1A, an aperture 213a is provided to part of the color filter 213 that covers the light shielding pattern 212. With this, a concave part 214a is formed on the planarizing film 214 that covers the color filter 213, and the spacer 24 is fixed onto the planarizing film 214 including this concave part, thereby increasing intimate contact between the spacer 24 and the planarizing film 214.

Also, by controlling the size of the aperture of the color filter 213, the concave part of the planarizing film 214 can be controlled, and therefore, the size of the concave part 241a of the spacer 24 can be easily adjusted.

In the foregoing, while the specific embodiments of the present invention have been described, the present invention is not meant to be restricted to these.

While the spacer 24 is fixed to the CF substrate in the embodiments described above, the spacer 24 may be fixed to the TFT substrate, and the top portion 241 of the spacer 24 may be provided in the vicinity of the CF substrate.

While the liquid crystal panel 2 of a horizontal electric field type is described in the liquid crystal display devices 1 and 1A, a vertical electric field type may be adopted as the liquid crystal display panel 2 or, unlike an active matrix type, a liquid crystal display device of a passive matrix type not using a thin film transistor may be used.

What is claimed is:

1. A liquid crystal display device comprising:
a first substrate;
a second substrate on which an orientation film is formed to face the first substrate;
a liquid crystal layer interposed between the first substrate and the orientation film formed on the second substrate and;
a spacer fixed to the first substrate
wherein the spacer comprises
a top portion facing the orientation film and having a concave part at a central area of the top portion and
a side surface having a convex surface curved from the top portion to the first substrate.

2. The liquid crystal display device according to claim 1; wherein an inner surface of the concave part includes a curved surface from a periphery of the concave part to a bottom part of the concave part.

3. The liquid crystal display device according to claim 1; wherein the top portion and the concave part have a round shape in planer view.

4. The liquid crystal display device according to claim 1,
wherein each of the first substrate and the second substrate has a display region and a non-display region outside of the display region,
wherein a plurality of spacers are arranged in the display region and the non-display region, and
wherein a size of the concave part of the spacer in the display region is smaller than a size of the concave part of the spacer in the non-display region.

5. The liquid crystal display device according to claim 1; further comprising:
a light shielding pattern formed on the first substrate,
wherein the spacer overlaps the light shielding pattern.

6. The liquid crystal display device according to claim 5; further comprising:
a color filter formed on the first substrate and being adjacent to the light shielding pattern,
wherein a part of the color filter covers the light shielding pattern.

7. The liquid crystal display device according to claim 6; wherein
the color filter has an apertural part and
the spacer is formed at the apertural part of the color filter.
